(19) United States
(12) Patent Application Publication
(10) Pub. No.: US 2022/0057213 A1
(43) Pub. Date: Feb. 24, 2022

(54) VISION-BASED NAVIGATION SYSTEM

(71) Applicants: ABHAY SINGHAL, Palo Alto, CA (US); STEFANO FANTINI DELMANTO, Sao Paulo (BR); FREDDY RABBAT NETO, Palo Alto, CA (US)

(72) Inventors: ABHAY SINGHAL, Palo Alto, CA (US); STEFANO FANTINI DELMANTO, Sao Paulo (BR); FREDDY RABBAT NETO, Palo Alto, CA (US)

(21) Appl. No.: 17/391,018

(22) Filed: Aug. 1, 2021

Related U.S. Application Data
(60) Provisional application No. 63/059,946, filed on Jul. 31, 2020.
(60) Provisional application No. 63/092,509, filed on Oct. 16, 2020.

(51) Int. Cl. G01C 21/16; G01S 17/89; G06T 7/73

(52) U.S. Cl. CPC G01C 21/1656; G01C 21/1652; G06T 2207/20081; G06T 7/74; G06T 2207/20084; G01S 17/89

(57) ABSTRACT

A method for integrating a vision-based navigation system into an aircraft navigation algorithm includes the step of obtaining a previous aircraft location as a latitude-longitude grid coordinate; implementing vision odometry based location determination with several steps. The method includes the step of using one or more digital cameras to obtain a set of digital images of the landscape beneath the aircraft, identifying a set of key points in the landscape using a specified feature point detection algorithm. The method includes the step of detecting a movement in the set of key points between two frames in a time interval. The method includes the step of, based on the movement of the set of key points between the two frames to infer the motion attributes of the aircraft. The method includes the step of locating aircraft imagery by matching it against a georeferenced satellite imagery database. The method includes the step of combining visual odometry and satellite imagery matching methods to obtain aircraft location.

### CLAIM OF PRIORITY

This application claims the benefit of U.S. Provisional Patent Application No. 63/059,946 filed on 31 Jul. 2020, and entitled METHODS AND SYSTEMS FOR NAVIGATION which is incorporated by reference herein.

This application claims the benefit of U.S. Provisional Patent Application No. 63/092,509 filed on 16 Oct. 2020, and entitled VISION-BASED NAVIGATION SYSTEM which is incorporated by reference herein.

### BACKGROUND

### Field of the Invention

The present invention is in the field of aircraft navigation and computer vision and more particularly to vision-based navigation system.

### Related Art

Aerial missions can be cancelled in GPS-denied environments as precise pointing and navigation without GPS may be impossible. This problem is only growing as more adversaries develop increasingly large-scale GPS jamming capabilities. Accordingly, improvements to aircraft navigation without GPS are desired.

### SUMMARY OF THE INVENTION

A method for integrating a vision-based navigation system into an aircraft navigation algorithm includes the step of obtaining a previous aircraft location. The previous aircraft location comprises a latitude-longitude grid coordinate; implementing vision odometry based location determination with several steps. The method includes the step of using one or more digital cameras to obtain a set of digital images of the landscape beneath the aircraft, identifying a set of key points in the landscape using a specified feature point detection algorithm. The method includes the step of detecting a movement in the set of key points between two frames in a time interval. The method includes the step of, based on the movement of the set of key points between the two frames to infer the motion attributes of the aircraft. The method includes the step of calculating a new latitude-longitude grid coordinates of the aircraft based on the inferred motion attributes of the aircraft. The method includes the step of updating the aircraft location as the new latitude-longitude grid coordinates. The method includes the step of implementing a satellite image matching based location determination by: using a database of high-resolution satellite images. Each image in database of high-resolution satellite images is georeferenced. The database of high-resolution satellite images is stored in a memory system on the aircraft or a server. The method includes the step of comparing the set of digital images of the landscape beneath the aircraft, to high-resolution satellite images to obtain a match of location. The method includes the step of including a satellite image derived latitude and longitude. The method includes the step of updating the new latitude and longitude coordinates based on the satellite image derived latitude and longitude.

### BRIEF DESCRIPTION OF THE DRAWINGS

FIG. 1 illustrates an example process for integrating a vision-based navigation system into an aircraft navigation algorithm, according to some embodiments.

FIG. 2 illustrates an example process for implementing a vision-based navigation system, according to some embodiments.

FIG. 3 illustrates an example process for determining an aircraft's location with visual odometry, according to some embodiments.

FIG. 4 illustrates an example process for implementing satellite image matching, according to some embodiments.

FIG. 5 illustrates an example vision-based navigation system integrated with an aircraft navigation system, according to some embodiments.

FIG. 6 is a block diagram of a sample computing environment that can be utilized to implement various embodiments.

FIGS. 7 and 8 illustrate example image frames used by some example embodiments.

The Figures described above are a representative set and are not exhaustive with respect to embodying the invention.

### DESCRIPTION

Disclosed are a system, method, and article of manufacture for a vision-based navigation system. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ an embodiment,' one example,' or similar language means that a particular feature, structure, or characteristic described in connection with the embodiment is included in at least one embodiment of the present invention. Thus, appearances of the phrases ‘in one embodiment,’ in an embodiment,' and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Aircraft can include various flying machines (e.g. human piloted airplane, drones, helicopters, rockets, missiles, balloons, kites, etc.).

Convolutional neural network (CNN) is a class of deep neural networks that can analyze visual imagery. CNNs can be shift invariant and/or space invariant artificial neural networks (SIANN), based on their shared-weights architecture and translation invariance characteristics.

Deep neural network (DNN) is an artificial neural network (ANN) with multiple layers between the input and output layers. The DNN finds the correct mathematical manipulation to turn the input into the output, whether it be a linear relationship or a non-linear relationship. The network moves through the layers calculating the probability of each output. For example, a DNN that is trained to recognize dog breeds will go over the given image and calculate the probability that the dog in the image is a certain breed. The user can review the results and select which probabilities the network should display (above a certain threshold, etc.) and return the proposed label.

DTED (Digital Terrain Elevation Data) is a standard of digital datasets which consists of a matrix of terrain elevation values.

Infrared (FLIR) cameras use a thermographic camera that senses infrared radiation.

These can be forward-looking, downward-looking, a combination of orientations, etc.

Global Positioning System (GPS) is a satellite-based radionavigation system owned by the United States government and operated by the United States Space Force. It is noted that other GPS systems can be utilized as well. These can include, GNSS, various GPS augmentation techniques, etc.

Image histogram is a type of histogram that acts as a graphical representation of the tonal distribution in a digital image.

Inertial navigation system (INS) is a navigation device that uses a computer, motion sensors (e.g. accelerometers, etc.) and rotation sensors (e.g. gyroscopes, etc.) to continuously calculate by dead reckoning the position, the orientation, and the velocity (e.g. direction and speed of movement) of a moving object without the need for external references.

Kalman filter can use a linear quadratic estimation (LQE). It can use a series of measurements observed over time. These can include statistical noise and other inaccuracies. The Kalman filter can produce estimates of unknown variables that are more accurate than those based on a single measurement alone, by estimating a joint probability distribution over the variables for each timeframe. In some embodiments, other filters (e.g. particle filters, etc.) can be used in lieu of and/or in addition to Kalman filters.

Key point can be a spatial location in a digital image that defines an area of interest.

Lidar can be used to measure distances by illuminating the target with laser light and measuring the reflection with a sensor. Differences in laser return times and wavelengths can then be used to make digital 3-D representations of the target.

Machine learning can include the construction and study of systems that can learn from data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

Photogrammetry is the science and technology of obtaining reliable information about physical objects and the environment through the process of recording, measuring, and interpreting photographic images and patterns of electromagnetic radiant imagery and other phenomena.

Scale-invariant feature transform (SIFT) is a feature detection algorithm in computer vision to detect and describe local features in images. SIFT key points of objects are first extracted from a set of reference images and stored in a database. An object is recognized in a new image by individually comparing each feature from the new image to this database and finding candidate matching features based on Euclidean distance of their feature vectors. From the full set of matches, subsets of key points that agree on the object and its location, scale, and orientation in the new image are identified to filter out good matches. The determination of consistent clusters is performed rapidly by using an efficient hash table implementation of the generalized Hough transform. Each cluster of 3 or more features that agree on an object and its pose is then subject to further detailed model verification and subsequently outliers are discarded. Finally, the probability that a particular set of features indicates the presence of an object is computed, given the accuracy of fit and number of probable false matches. Object matches that pass all these tests can be identified as correct with high confidence. SIFT descriptors are a 128-vector defined as a set of oriented gradient histograms taken over a defined pixel space and Gaussian window. SIFT descriptors can be calculated over a whole image or image subset and can thus be used for image patch matching.

Synthetic-aperture radar (SAR) is a form of radar that is used to create two-dimensional images or three-dimensional reconstructions of landscapes.

Visual odometry can be used to determine the position and orientation of an aircraft by analyzing digital images taken from the aircraft.

EXAMPLE SYSTEMS AND PROCESSES

Disclosed are a vision-based navigation system that leverages an aircraft's existing sensors to output accurate latitude-longitude (i.e. lat-long) grid coordinates. In some example embodiments, these can be at approximately one-meter of precision, GPS-like precision, or user-defined precision. The vision-based navigation system can take as input various onboard visible light, night vision, and infrared (IR) cameras in a target acquisition designation system. It can also use synthetic aperture radar. It can also use compass, INS, and magnetometer readings. It can reference a georeferenced image, NIR, or DTED database (e.g. high-resolution satellite image database 210, etc.). The vision-based navigation system can output lat-long grid (e.g. GPS-like, etc.) coordinates. The vision-based navigation system can be a passive, vision-based navigation system in some examples.

The vision-based navigation system can combine existing visual sensor feeds to build a tri-part navigation system that integrates into existing navigation systems as GPS does. The vision-based navigation system can combine visual inertial odometry (VIO), satellite imagery matching, and radar topographic mapping.

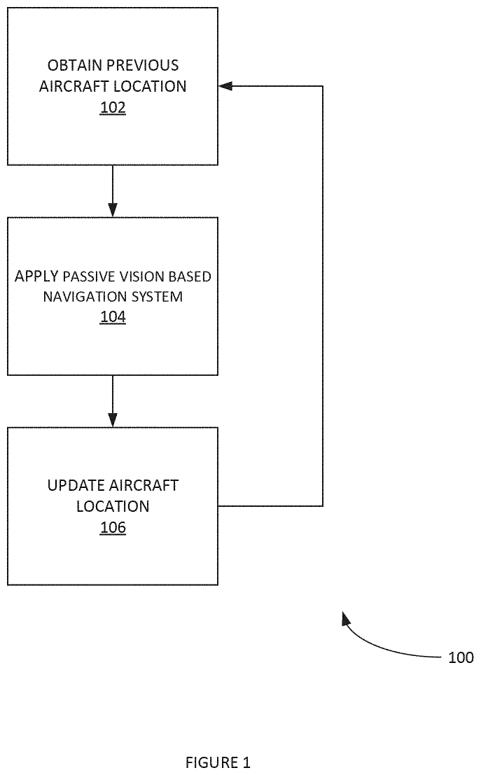

FIG. 1 illustrates an example process for integrating a vision-based navigation system into an aircraft navigation algorithm, according to some embodiments. In step 102, process 100 can obtain previous aircraft location. The previous aircraft location can have been determined via various known aircraft navigational techniques (e.g. GPS systems, etc.) and/or use of a vision-based navigation system. This can be a rough estimate of the previous aircraft location, such as that used when calibrating an INS before takeoff from base. The use of a vision-based navigation system can be initiated when a GPS signal is lost (e.g. jammed, etc.) and/or when a spoofing of an incorrect GPS signal is detected. In step 104, process 100 uses a vision-based navigation system. In step 106, process 100 can use the output of step 104 to update the aircraft's location. Step 104 can be repeated until a trusted GPS signal and/or other navigational technique is functional. Additionally, a vision-based navigation system can be run in the background to verify GPS and/or other navigational system outputs.

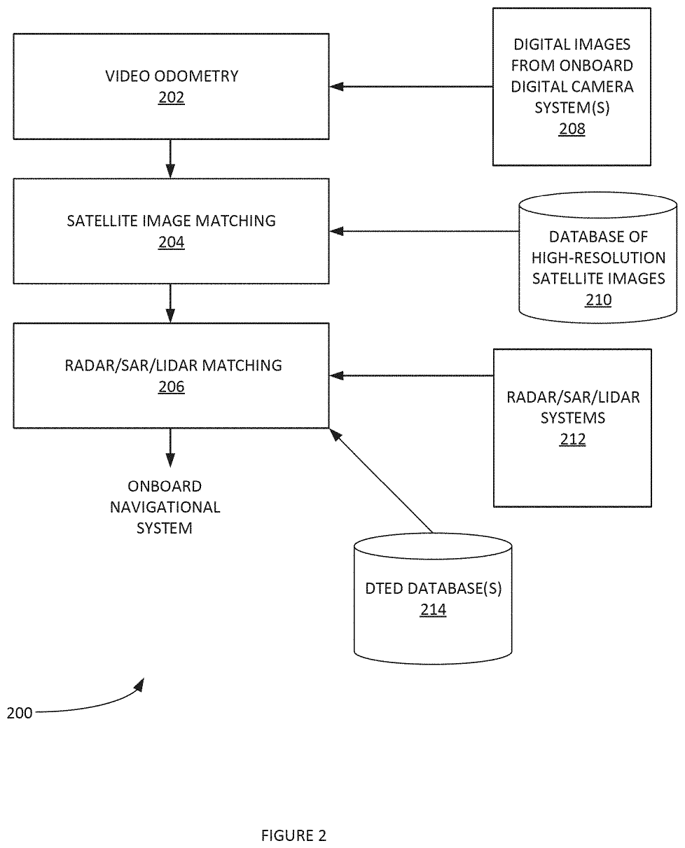

FIG. 2 illustrates an example process 200 for implementing a vision-based navigation system, according to some embodiments. In step 202, process 200 can determine an aircraft location using visual odometry. Digital images can be obtained from digital camera(s) 208, radars, or other imaging sensors on board the aircraft. Digital camera(s) 208 can be downward facing when the aircraft is in flight. These do not need to use a 360-degree view, but rather can use downward-facing sensor imagery. The location can be expressed in terms of lat-long coordinates. For example, process 200 can use process 300.

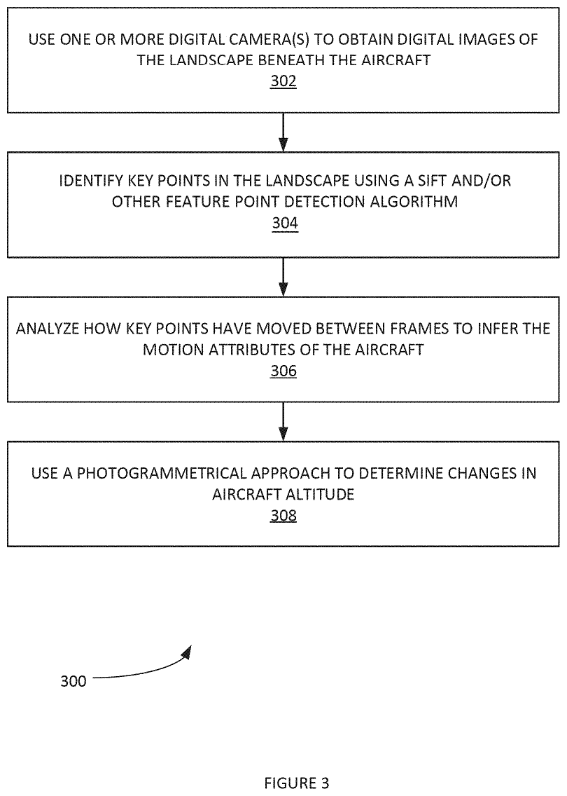

FIG. 3 illustrates an example process 300 for determining an aircraft's location with visual odometry, according to some embodiments. In step 302, process 300 can use one or more digital camera(s) 208 to obtain digital images of the landscape beneath the aircraft. In step 304, process 300 can identify key points in the landscape using a SIFT and/or other feature point detection algorithm. In step 306, process 300 can then analyze how key points have moved between frames to infer the motion of the aircraft. This can be relative to a previously determined position in terms of lat-long coordinates. In this way, the location of the aircraft can be determined. The direction, velocity, acceleration, and other aircraft travel datapoints can also be inferred as well. Optionally, in step 308, process 300 can use a photogrammetrical approach to determine changes in aircraft altitude. Altitude can be investigated through photogrammetric successive image scale shifts. Step 308 can use visual odometry and analysis of changes in the landscape images.

In an alternate embodiment, process 300 can implement visual odometry as follows. Digital camera(s) take in imagery. These digital camera(s) may or may not be downward-facing. Process 300 can implement a SLAM (simultaneous localization and mapping) algorithm to obtain an estimate of location and pose. In other embodiments, process 300 can use a deep neural network implementation of visual odometry, as well as other visual odometry packages in lieu of and/or to supplement a SLAM analysis.

In one example, process 300 can use a VIO component. The VIO component can act as a visual INS by measuring optical flow. As noted, the VIO component can use SIFT to detect features for each frame. The VIO component can then compare successive frames to compare the movement of common features and infer the aircraft's movement. In some embodiments, VIO works well at the SOCOM aircraft's low altitudes as features are clear and detectable and provides continuous position updates if any other component of the system cannot get a confident match in any frame. Process 300 can use a satellite imagery matching component, as it outputs lat-long coordinates independent of previous positions. Process 300 can return an absolute lat-long position for every frame. In one example, process 300 can use 0.8 m resolution satellite imagery (e.g. in both RGB and IR) updated frequently (and 3 m resolution imagery updated daily) to use as a georeferenced image database. Process 300 can obtain digital images with a downward-facing camera (e.g. light, FLIR, night-vision, etc.) and run a search against the satellite imagery database. When an aircraft is using its INS and VIO, it has an estimate of its present location.

It is noted that combining SLAM/visual odometry with inertial sensors to constrain search space using a particle filter. Each particle represents a (lat, long, altitude) determination within a particular probability distribution, and based on each particle, the system is checking that and nearby location in the satellite imagery.

Returning to process 200, in step 204 process 200 can implement satellite image matching. Step 204 can use a database of high-resolution satellite images 210. Each image in database of high-resolution satellite images 210 can be georeferenced. Database of high-resolution satellite images 210 can be stored in a memory system on the aircraft. It is noted that, in one example, while onboard storage can be used for passivity, for non-passive use cases, process 200 can also obtain the imagery from a server.

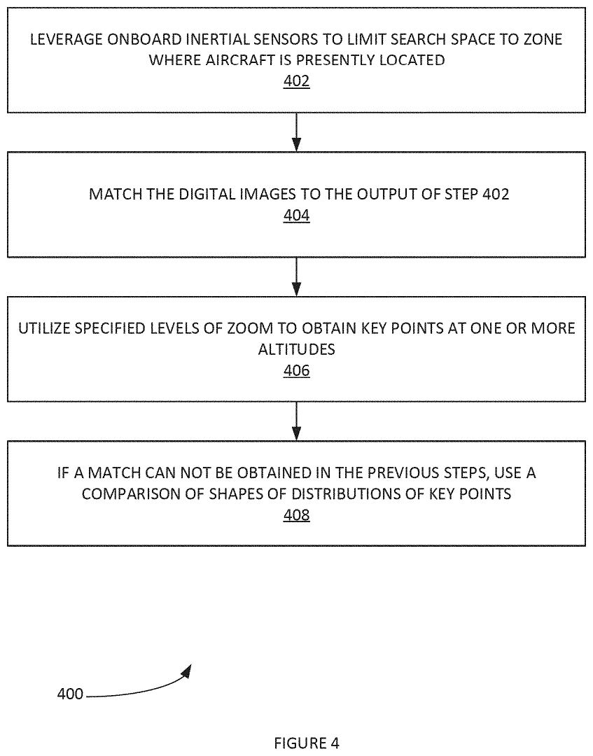

FIG. 4 illustrates an example process 400 for implementing satellite image matching, according to some embodiments. Process 400 can use a database of high resolution frequently updated satellite images 210. It is noted that database of high resolution frequently updated satellite images 210 can be updated on a periodic basis (e.g. daily, weekly monthly, etc.). Process 400 can compare digital images of the ground below the aircraft to satellite images to obtain an exact match of location, including latitude, longitude, and altitude. In step 402, process 400 can leverage onboard inertial sensors and/or process 300 to limit search space to the zone where aircraft is presently located. In this way, process 400 can constrain the satellite imagery search space.

In step 404, process 400 can match the digital images to the output of step 402. Process 400 can use a CNN to implement image featurization and matching. These CNN matching approaches can include:
Separately semantically segmenting the aircraft and satellite images into encoded maps of various classes of landmarks and/or landcover and finding maps that best correlate using a search algorithm or sliding window;
Using a Siamese CNN to calculate similarity between an aircraft image and a satellite image to find the satellite image most similar to the aircraft image using a search algorithm or sliding window; and
Using a CNN architected to perform template matching.

It is noted that, in other embodiments, less computationally expensive algorithms can also be used.

In general, an image matching algorithm can first reduce images to feature lower-dimension feature representations which can include semantic, key point or histogram mappings. The same image-to-feature algorithm can be used on both the aircraft imagery and the search space of the satellite imagery. The feature representation of the aircraft imagery can then be compared against patches of the database imagery feature representations using a search algorithm or sliding window. Alternatively, one algorithm or model could perform both the image-to-feature and search step to output the closest match between the satellite and aircraft imagery.

In each iteration of step 404, in some embodiments, process 400 can preprocess imagery obtained from aircraft sensors to match its aspect ratio, scale (distance/pixel), and orientation to that of the queried database. Upon finding a match, it can then reverse this preprocessing in determining position. Alternatively, in other embodiments, process 400 can implicitly use apply transformations as part of using a CNN in step 404.

The matching process can use key points by running a SIFT on satellite images. In step 406, process 400 can utilize specified levels of zoom to obtain key points at one or more altitudes. In this way, process 400 can compare key point identifiers between the satellite image and the digital picture of the ground. In step 408, if a match can not be obtained in the previous steps, process 400 can use a comparison of shapes of distributions of key points. It is noted that a key point can be a set of points/areas of a digital image that are locally distinct in terms of their pixels when compared to surrounding pixels. Process 400 can use a key point identifier that is a condensed image histogram of the surrounding points. Once a match is identified against a georeferenced satellite image, location can be inferred.

Process 400 can also use specified zoom levels to obtain SIFT descriptors of image subsets (e.g. “patches”) defined by a sliding window . The same patch SIFT descriptor process can be repeated on the georeferenced image database defined by a sliding window of the same size. These patches can then be matched based on their descriptors' similarity such that the most similar patches correspond to the same place. As such, since the georeferenced image corresponds to the camera image, lat-long can be inferred.

Returning to process 200, in step 206, radar/SAR/Lidar data can be obtained. The radar/SAR/Lidar can be compared/matched against DTED database(s) 212 to determine a 10 location. Step 206 can be optional in some embodiments. Step 206 can provide navigation capability in visually degraded environments and can function as an emergency protocol. Leveraging sensor fusion, each of the three parts serves as a redundancy if one part fails in certain conditions.

It is noted that various permutations of steps 202-206 can be utilized. If one step fails, the others can take over to aid navigation. For example, at low altitudes, VIO can provide a higher confidence of location than satellite imagery of step 204. At high altitudes, even individual feature movement is harder to detect, satellite imagery matching is more effective. Additionally, in war-torn environments, although the satellite imagery updates frequently, if scene matching cannot confidently yield a reasonable match, then VIO can be utilized.

Example Computing Systems

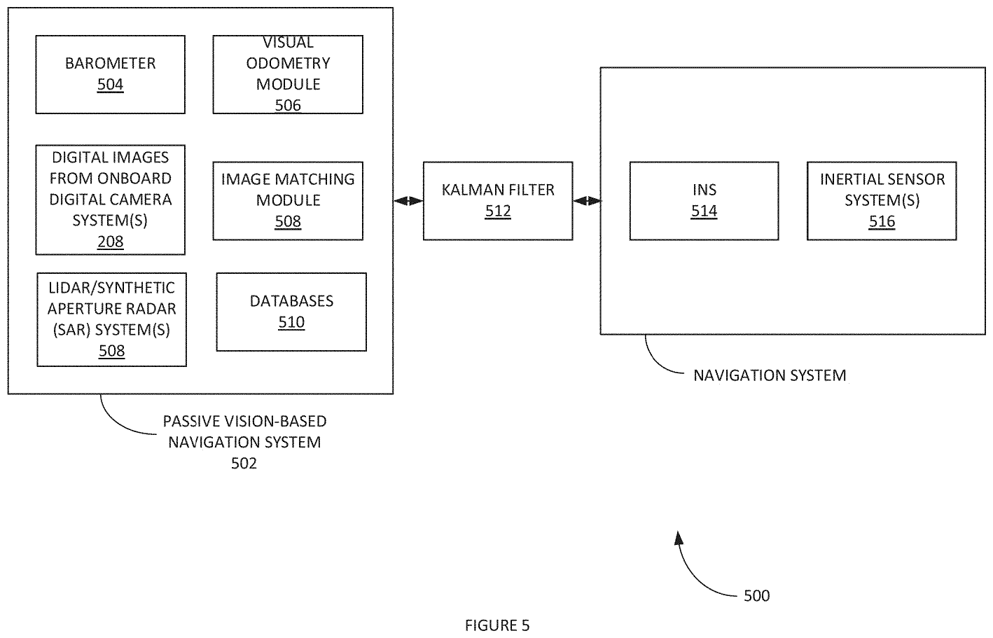

FIG. 5 illustrates an example vision-based navigation system 502 integrated with an aircraft navigation system, according to some embodiments. Vision-based navigation system 502 can implement the various relevant steps of processes 100-400 discussed supra. Vision-based navigation system 502 can include a barometer 504. Barometer 504 can obtain air pressure measurements. These can be used to estimate aircraft altitude. Visual odometry module 506 can manage visual odometry algorithms. The outputs of visual odometry module 506 can be provided to Kalman filter 512. Image matching module 508 can implement image searches and matching algorithms. The outputs of image matching module 506 can be provided to Kalman filter 512. The outputs of visual odometry module 506 and image matching module 508 can be provided to a particle filter, in which they are merged based on both modules' confidence in their predictions (expressed as probabilities). The output of this particle filter can be provided to Kalman filter 512. Databases 510 can include high-resolution satellite image database 210, digital images from onboard digital camera system(s) 208, and DTED database

Lidar/Synthetic Aperture Radar (SAR) system(S) 508 can obtain radar and/or other ground data. Other systems can be included in Vision-based navigation system 502 such as, inter alia: downward faces digital cameras, the various systems of computing system 600, infrared camera systems, etc.

Kalman filter 512 can implement position fusion with the outputs of vision-based navigation system 502 and navigation system 518. Navigation system 518 can include INS 514 and inertial sensor system(s) 516. The systems of FIG. 5 are provided by way of illustration and not of limitation. In other embodiments, other permutations of these systems as well as additional systems can be provided.

System 500 can be a navigation system used to detect GPS signal loss or spoofing, in which case, system 500 can be run concurrent to GPS, so it may be useful to keep this use-case open.

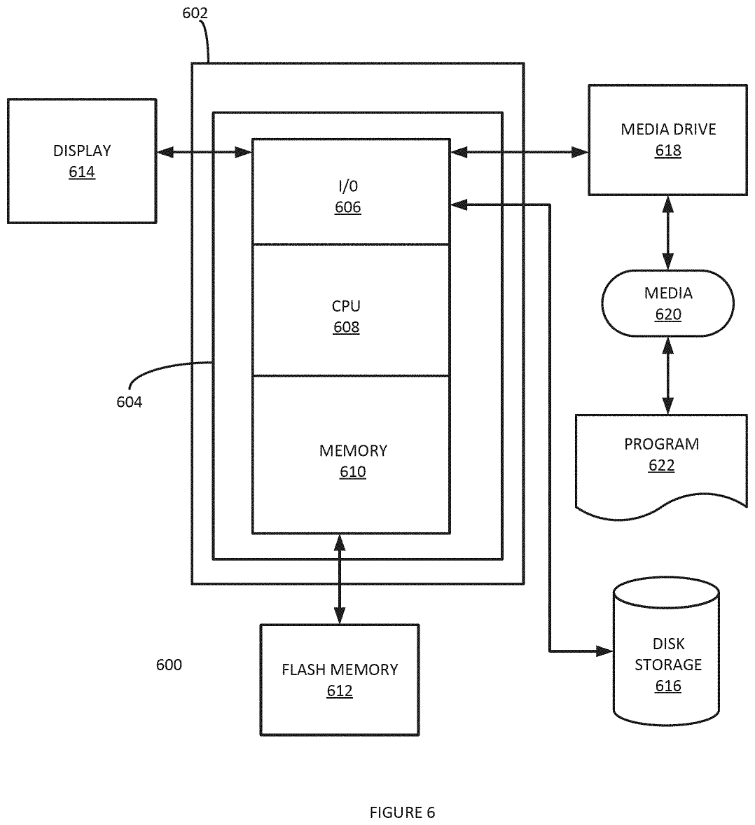

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities. Computing system 600 can communicate with other computing devices based on various computer communication protocols such a Wi-Fi, Bluetooth° (and/or other standards for exchanging data over short distances includes those using short-wavelength radio transmissions), USB, Ethernet, cellular, an ultrasonic local area communication protocol, etc.

### Example Digital Images

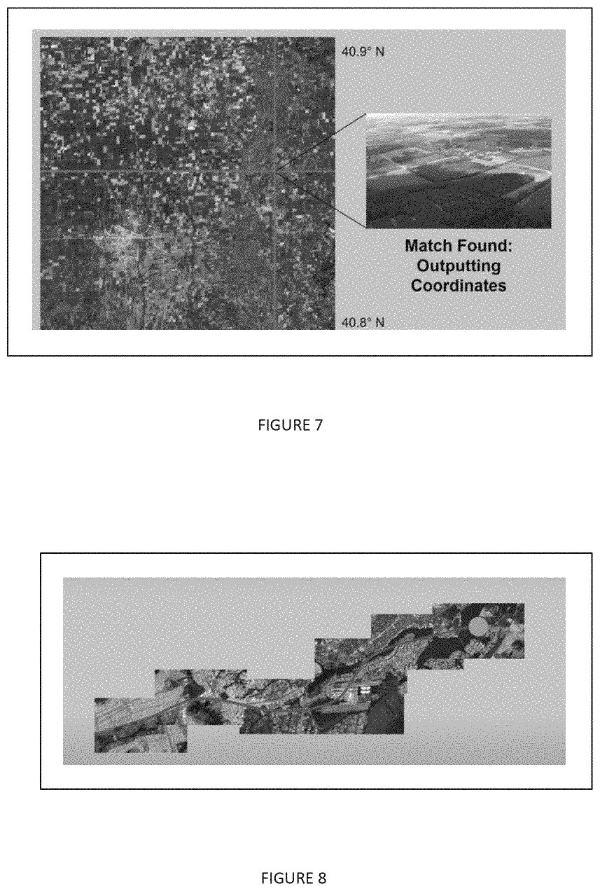

FIGS. 7 and 8 illustrate example image frames used by some example embodiments. More specifically, FIG. 7 illustrates an example image frame with the estimated location of the aircraft. FIG. 8 illustrates a series of frames connected together showing a trajectory of the aircraft.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States Patent is:

1. A method for integrating a vision-based navigation system into an aircraft navigation algorithm comprising:
obtaining a previous aircraft location, wherein the previous aircraft location comprises a latitude-longitude grid coordinate;
implementing vision odometry based location determination by:
using one or more digital cameras to obtain a set of digital images of the landscape beneath the aircraft,
identifying a set of key points in the landscape using a specified feature point detection algorithm,
detecting a movement in the set of key points between two frames in a time interval,
based on the movement of the set of key points between the two frames to infer the motion attributes of the aircraft, and
calculating a new latitude-longitude grid coordinates of the aircraft based on the inferred motion attributes of the aircraft,
updating the aircraft location as the new latitude-longitude grid coordinates; and
implementing a satellite image matching based location determination by:
using a database of high-resolution satellite images, wherein each image in database of high-resolution satellite images is georeferenced, wherein the database of high-resolution satellite images is stored in a memory system on the aircraft or a server,
comparing the set of digital images of the landscape beneath the aircraft, to high-resolution satellite images to obtain a match of location, including a satellite image derived latitude and longitude, and
updating the new latitude and longitude coordinates based on the satellite image derived latitude and longitude.
updating location estimates by:
combining the latitude and longitude estimates from visual odometry and matching algorithms based on probabilistic certainty estimates of each algorithm

2. The method of claim 1, wherein the step of obtain the previous aircraft location comprises obtaining the previous aircraft location as determined by a GPS aircraft navigational techniques.

3. The method of claim 1, wherein the vision-based navigation system is initiated as the sole navigation system when a GPS signal is lost.

4. The method of claim 1, wherein the vision-based navigation system is initiated as the sole navigation system a spoofing of an incorrect GPS signal is detected.

5. The method of claim 1, wherein the feature point detection comprises a feature detection algorithm used to detect and describe one or more local features in images of a landscape below the aircraft.

6. The method of claim 1 further comprising:
using a photogrammetrical approach to determine changes in an aircraft altitude.

7. The method of claim 6, wherein the photogrammetrical approach determines altitude through a set of photogrammetric successive image scale shifts.

8. The method of claim 7, wherein the photogrammetrical approach uses a visual odometry and an analysis of changes in the landscape images to update the set of photogrammetric successive image scale shifts.

9. The method of claim 1 further comprising:
leveraging a set of onboard inertial and visual sensors to limit a search space to a zone where aircraft is presently located to constrain a satellite imagery search space.

10. The method of claim 1 further comprising:
implementing a radar/SAR/Lidar-data based location determination by:
obtaining a radar/SAR/Lidar data of the landscape beneath the aircraft, wherein the radar/SAR/Lidar data is matched against a DIED database to determine the radar/SAR/Lidar-data based location, and
determining a radar/SAR/Lidar data-based latitude and longitude coordinates based the matching of the radar/SAR/Lidar data against the DTED databases.

11. The method of claim 10, wherein the radar/SAR/Lidar-data based location determination is implemented to provide a navigation capability in a visually degraded environment.

12. The method of claim 10 further comprising:
updating the new latitude and longitude coordinates or the satellite image derived latitude and longitude based on the radar/SAR/Lidar data-based latitude and longitude coordinates.

13. The method of claim 10, wherein a CNN is used to implement the matching of the radar/SAR/Lidar data against the DTED databases.

14. The method of claim 1, wherein another CNN is used to implementing the matching the satellite images to the high-resolution satellite images.

15. The method of claim 1, wherein the preprocess imagery is obtained from one or more aircraft sensors to match an aspect ratio, a distance/pixel scale, and an orientation to that of the queried database and upon finding a match, this information is reversed to determining the aircraft's position in terms of latitude and longitude.

16. The method of claim 1, wherein the step of comparing the set of digital images of the landscape beneath the aircraft, to high-resolution satellite images to obtain a match of location, including a satellite image derived latitude, longitude further comprises matching an altitude of the aircraft.
